(19) United States
(12) Patent Application Publication
(10) Pub. No.: US 2009/0121433 A1
(43) Pub. Date: May 14, 2009

(54) Draw poker with bonus bet

(75) Inventors: Roger M. Snow, Las Vegas, NV (US); Mark L. Yoseloff, Henderson, NV (US)

Correspondence Address: Dickstein Shapiro LLP, 1825 Eye Street NW, Washington, DC, 20006, US

(73) Assignee: Shuffle Master, Inc.

(21) Appl. No.: 11/983,481

(22) Filed: Nov. 9, 2007

(51) Int. Cl. A63F 1/00; A63F 13/00

(52) U.S. Cl. 273/292; 463/16

(57) ABSTRACT

A draw poker card game with an optional side bet and methods for playing the game are disclosed. The method comprises dealing a plurality of cards and at least one draw card to each player and dealing a plurality of cards for a dealer whose quantity is at least one more than the plurality of cards dealt to each player. Each player is provided at least one opportunity to bet. Each player is then provided an opportunity to replace at least one card with the at least one draw card. Each player then identifies his or her best hand based on poker rankings and each player's hand is compared with the dealer hand after discarding at least one card from the dealer hand to form the dealer's best hand. The best poker hand wins.

### FIELD OF THE INVENTION

The present invention is directed to a card game, and more particularly to a variant game of poker.

### BACKGROUND OF THE INVENTION

Many different betting games presently exist for use in both home and casino environments. Such games should necessarily be exciting, not excessively complicated, and relatively easy to learn so as to avoid frustrating the players.

Poker games in particular have gained widespread popularity because of their well-known rules and long-established ranking of hands. Furthermore, poker games usually involve numerous betting opportunities for the players, thus increasing player participation and excitement. Poker games move fairly quickly, which enhances player interest. All of these factors have created poker games that are widely accepted and widely known.

Three Card Poker® as described in Webb et al., U.S. Pat. No. 6,698,759 and assigned to Shuffle Master, Inc. is one known poker game that uses a standard 52-card deck and allows players to bet against the dealer, bet on the value of the player's own hand, or both. FIG. 1 is a flowchart showing a method for playing one known Three Card Poker® game. As shown in FIG. 1, before cards are dealt, the first step 102 gives a player an option to place an Ante and/or Pair-Plus bets. By placing the Ante bet, the player is betting that his or her three card poker hand will have a higher three card poker ranking than the dealer's hand. The Pair-Plus bet, however, is a bet on the eventual value of a player's hand regardless of how it compares to the dealer's hand. The term “Pair-Plus” comes from the fact that the bet is paid only for hands containing a pair or better. Pair-Plus bets are paid according to a paytable, an example of which is shown in FIG. 2. To play, a player must place an Ante bet, a Pair-Plus bet, or both.

Referring again to FIG. 1, in the next step 103, the dealer deals three cards to each player and the dealer. In the next step 104, each player examines his or her cards. The next step 105 is to identify whether the player has placed an Ante bet, or if that player has only placed a Pair-Plus bet. If the player has not placed an Ante bet, the next step 111 for that player will be to receive payment from the dealer on the Pair-Plus bet according to a paytable, an example of which is shown in FIG. 2.

Referring again to FIG. 1, for each player who has placed an Ante bet, the next step 106 is for the player to decide, after viewing the player's cards, whether to bet on the strength of the player's hand compared to the dealer's yet unknown hand or fold. If the player decides to fold, the next step 107 for that player is to forfeit the Ante bet to the dealer. After folding, the next step 108 is to identify whether the folding player also placed a Pair-Plus bet. If the player did not also place a Pair-Plus bet, the game is over for that player. If the player did place a Pair-Plus bet, however, the next step 111 for that player will be to receive payment from the dealer on the Pair-Plus bet according to a paytable, an example of which is shown in FIG. 2.

Referring again to FIG. 1, looking back at step 106, if a player decides to bet the next step 109 for that player is to place a Play bet equal to the Ante bet. By placing a Play bet, the player is betting that his or her hand has a higher three card poker ranking than that of the dealer's hand. After Play bets are placed, the next step 110 requires the dealer to reveal his or her cards. At this time, or at any time after the cards are dealt, the next step 1 11 is for the dealer to pay all winning Pair-Plus bets according to a paytable, an example of which is shown in FIG. 2.

Referring again to FIG. 1, after Pair-Plus bets are paid, the next step 112 is to determine whether the dealer's hand qualifies. A dealer's hand typically qualifies with a queen or better. If the dealer's hand does not qualify, the next step 113 is that the Ante wins and the Play bet pushes. The play bet is returned to the players who have not folded, and the game is over. If the dealer's hand does qualify, however, the next step 114 is to determine whether the player's hand beats the dealer's by comparing the three card poker ranking of the hands. Three Card poker rankings are typically different from traditional five card poker rankings. Typically, cards are ranked from highest to lowest as follows: straight flush, three of a kind, straight, flush, pair. If a hand does not contain a pair or better, the hand that contains the highest ranking card wins with an Ace being high. An Ace is low, however, when used in an A-2-3 straight.

If a player's hand does not beat the dealer's hand by having a higher three card poker ranking, the next step 115 for that player is to forfeit the Ante and Play bets to the dealer and the game is over for that player. If the player's hand does beat the dealer's hand, however, the next step 116 is for the dealer to pay the Ante and Play bets which are typically paid 1 to 1. After the Ante and Play bets are paid, the next step 117 is to identify whether the player has one of the three highest ranking three card poker hands; straight flush, three of a kind or straight. If the player does have one of these hands, the next and final step 118 requires the dealer to pay the player an Ante Bonus based on an Ante Bonus paytable, examples of which are shown in FIG. 3. This payout is “automatic”, meaning that it is payable without the player making a separate wager on its occurrence.

The game described above and in reference to FIGS. 1-3 can also be played with four cards, called Four Card Poker. Four Card Poker is substantially the same as Three Card Poker, with a few exceptions. First, each player is dealt five cards to make a best four card hand. The dealer receives six cards to make a best four card hand. Second, the ranking of hands in Four Card Poker from highest to lowest is: four of a kind, straight flush, three of a kind, flush, straight, two pair. Next, the play wager can be a multiple of the ante, instead of being equal to the ante.

### BRIEF DESCRIPTION OF THE DRAWINGS

FIG. 1 is a flowchart illustrating a prior art method of playing the game Three Card Poker®.

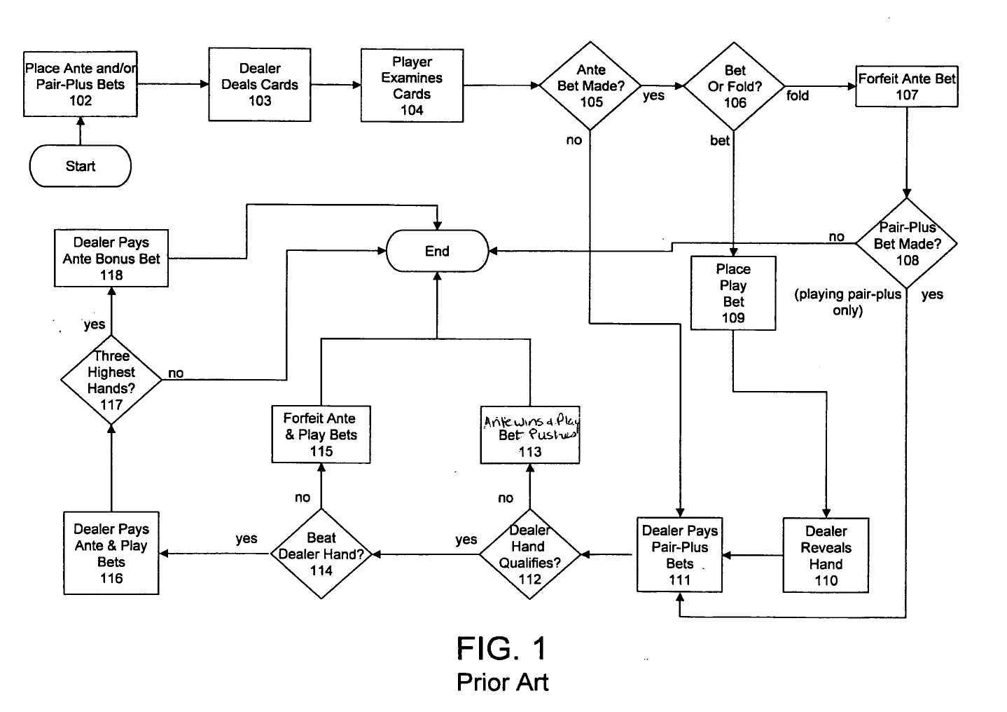

FIG. 2 is a prior art paytable for paying Pair-Plus bets in Three Card Poker®.

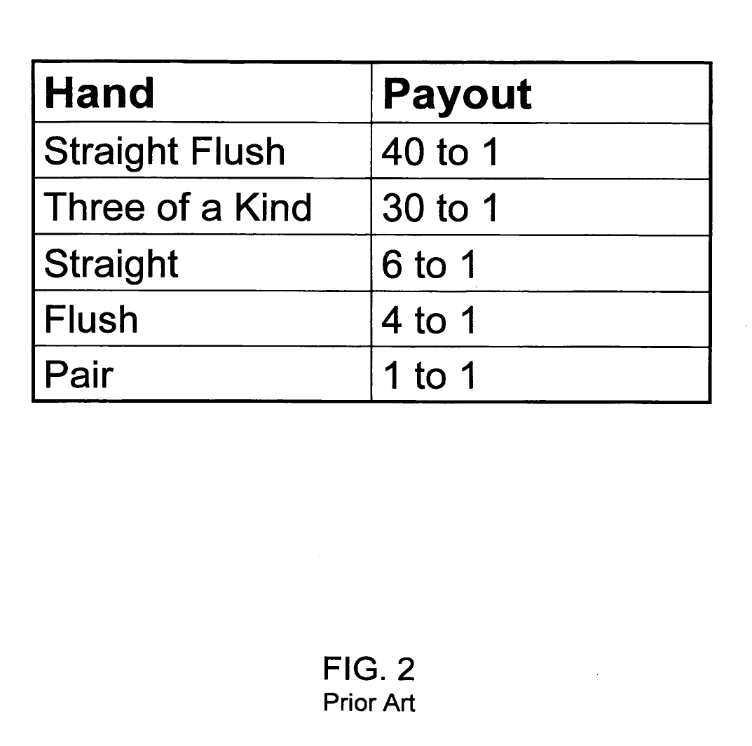

FIG. 3 is a prior art paytable for paying an Ante Bonus in Three Card Poker®.

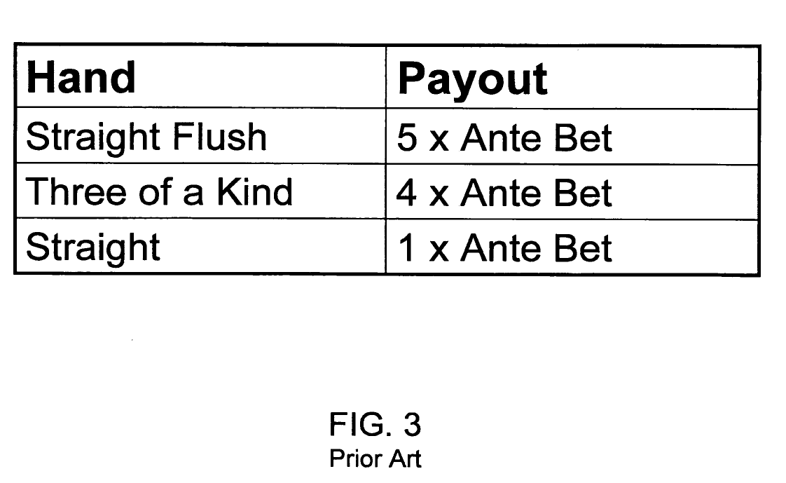

FIG. 4 is a flowchart illustrating a method of playing draw poker according to an embodiment described herein.

FIG. 4A is a flowchart illustrating a method of playing draw poker according to an embodiment described herein.

FIG. 5 is a paytable for paying Bonus bets in draw poker according to an embodiment described herein.

FIG. 6 is a paytable for paying an Ante Bonus in draw poker according to an embodiment described herein.

FIG. 7 is a flowchart illustrating a method of playing draw poker according to an embodiment described herein.

FIG. 7A is a flowchart illustrating a method of playing draw poker according to an embodiment described herein.

FIG. 8 is a paytable for paying Bonus bets in draw poker according to an embodiment described herein.

FIG. 9 is a paytable for paying an Ante Bonus in draw poker according to an embodiment described herein.

FIG. 10 is a flowchart illustrating a method of playing draw poker according to an embodiment described herein.

FIG. 10A is a flowchart illustrating a method of playing draw poker according to an embodiment described herein.

FIG. 11 is a paytable for paying Bonus bets in draw poker according to an embodiment described herein.

FIG. 12 is a paytable for paying an Ante Bonus in draw poker according to an embodiment described herein.

FIG. 13 shows a game device for playing a game according to an embodiment described herein.

### DETAILED DESCRIPTION OF THE INVENTION

In the following detailed description, reference is made to various embodiments of the invention that are described with sufficient detail to enable those skilled in the art to practice them. It is to be understood that other embodiments may be employed, and that various changes may be made without departing from the scope of the invention. The progression of steps and device features described are exemplary of embodiments of the invention; however, the steps, sequence thereof, and devices are not limited to those set forth herein and may be changed, with the exception of steps necessarily occurring in a certain order.

Various embodiments described herein relate to a method for playing a variant of Three Card Poker® or Four Card Poker®. Furthermore, embodiments herein disclose a house-banked poker game where players bet against the dealer and may also place optional side bets that are paid according to a predetermined criteria independent of the dealer's hand. In addition, the embodiments disclosed allow players to replace at least one card in their hands with optional draw cards.

The embodiments described herein are only examples and the numbers of cards that can be dealt, replaced, discarded and used in a hand are not requirements, but may be changed within the scope of the invention. In a preferred embodiment, however, cards dealt to the dealer number at least one more than the cards dealt to each player. Also, while the preferred embodiments use one 52-card deck thus limiting the number of players that can play depending on the number of cards dealt, it should be understood that multiple decks can be used if desired. Furthermore, the games described in the embodiments are played between a dealer and at least one player.

The gaming methods described in this application may be played in a number of different formats, such as a live action casino gaming format with a live dealer and real playing cards and chips, or with various automated formats with partial or complete automation of the format. Such formats include traditional video gaming apparatus and modem multi-player platforms.

### Three Card Draw Variants

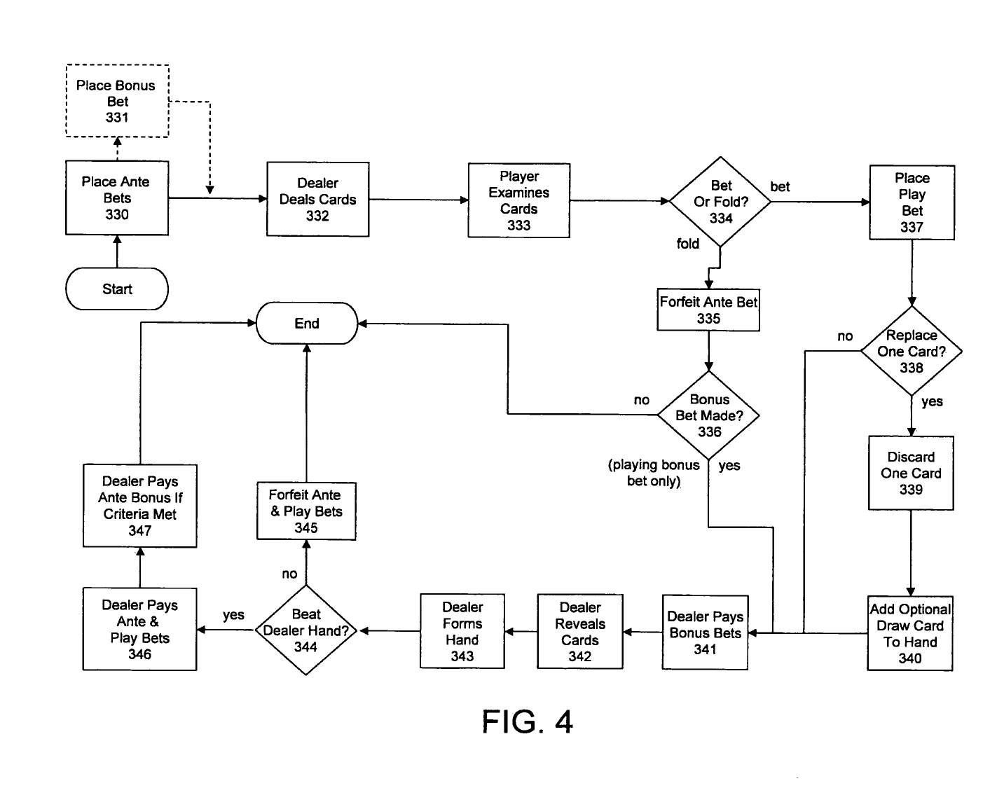

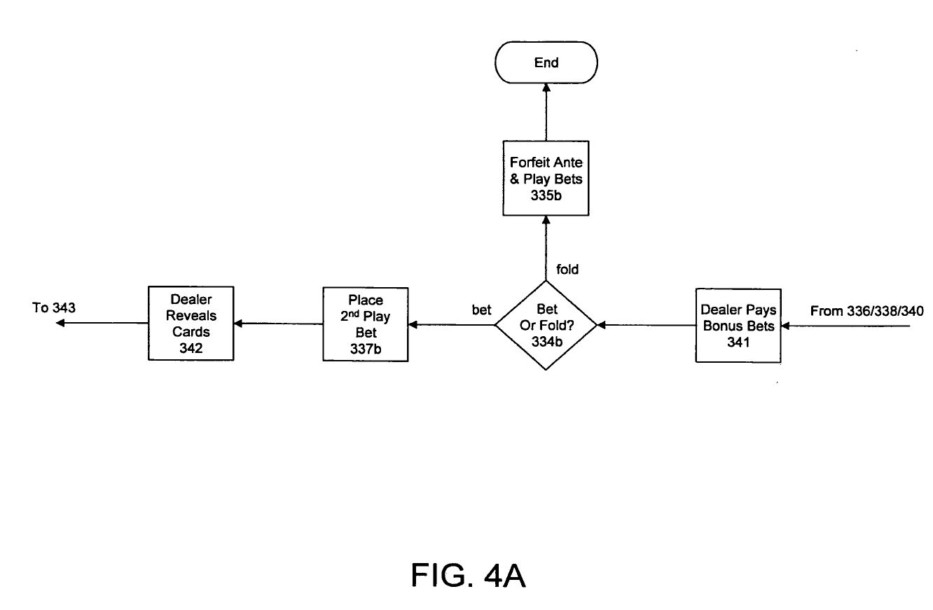

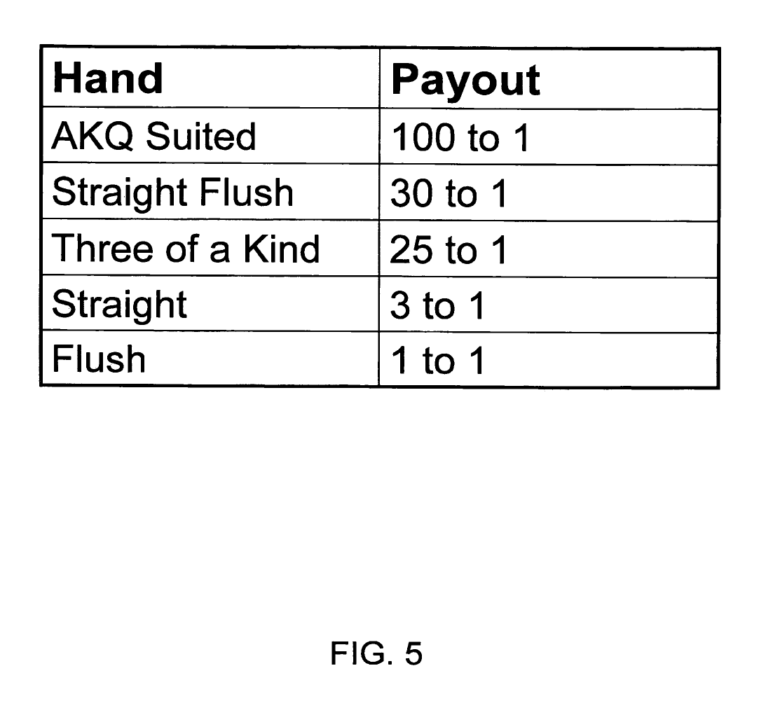

Now referring to the figures, FIG. 4 illustrates a method of the invention according to a first embodiment that uses three card poker hands. The first step 330 requires a player to place an Ante bet, whereby the player is betting that his or her eventual three card poker hand will have a higher three card poker ranking than the dealer. As an optional next step 331, the player may place a Bonus bet strictly on the eventual value of the player's own hand, which is paid independent of the dealer's hand according to a predetermined criteria. In a preferred embodiment, the predetermined criteria is a paytable, an example of which is shown in FIG. 5.

Referring again to FIG. 4, in the next step 332, three cards and one optional draw card are dealt to each player, all face down. The draw card is dealt into a separate area on the layout. Then four cards are dealt face down to the dealer. Card dealing can be performed manually by the dealer if desired, or a shuffler may be used to deliver prearranged hands of cards to the dealer. In the next step 333, each player examines his or her cards, except for the draw card.

After viewing his or her cards, the next step 334 for each player is to decide whether to bet on the strength of his or her hand compared to the dealer's still unknown hand or fold. If the player decides to fold, the next step 335 for that player is to forfeit the Ante bet to the dealer. After folding, the next step 336 is to identify whether the folding player also placed a Bonus bet in step 331. If the player did not also place a Bonus bet, the game is over for that player. If the player did place a Bonus bet, however, the next step 441 for that player will be to receive payment on the Bonus bet according to a predetermined criteria. In a preferred embodiment, the predetermined criteria is a paytable, an example of which is shown in FIG. 5. In another embodiment, the player automatically loses the bonus bet if he folds.

Referring again to step 334 in FIG. 4, if the player decides to bet that his or her hand has a higher three card poker ranking than that of the dealer's hand, the next step 337 for that player is to place a Play bet. In a preferred embodiment, the Play bet must be a multiple of the Ante bet, e.g., double or triple the Ante bet, preferably with a minimum Play bet equal to two times the Ante bet and a maximum Play bet equal to three times the Ante bet.

After all Play bets are placed by any remaining players, the next step 338 gives each player an option to replace one card in his or her hand with his or her optional draw card in an effort to better his or her hand. No additional wagers are required to use the draw card in this embodiment. In other embodiments, an additional wager must be made to use the draw card. If a player decides to replace a card, the next step 339 is to choose which card to replace, and discard that card, and then at step 340, to add the optional draw card to that player's hand to finalize the hand. While the preferred embodiment requires the player to discard one card before looking at the optional draw card, other embodiments may allow the player to look at the optional draw card before choosing which card to discard.

After each player has finalized his or her hand, the next step 341 requires the payment of all winning Bonus bets to players according to a predetermined criteria. In a preferred embodiment, the predetermined criteria is a paytable, an example of which is shown in FIG. 5. House rules may require the player to make a play bet to win on the bonus. In other embodiments, the player may fold yet still qualify for a bonus payout. After Bonus bets are paid, the next step 342 requires the dealer to reveal all four of his or her cards. In the next step 343, the dealer forms a hand by choosing three cards that form the highest-raking poker hand and discarding the fourth card. In a preferred embodiment, three card poker rankings are used, which rank cards from highest to lowest as follows: straight flush, three of a kind, straight, flush, pair. If no hand contains a pair or better, the hand that contains the highest ranking cards wins with an Ace being high. Aces are low, however, when used in an A-2-3 straight.

In an alternative embodiment shown in FIG. 4A, players may place a second Play bet after their hands are finalized and before the dealer's cards are revealed. Looking at step 334b, after the Bonus bets are paid to the players in step 341, each player will be given the option to place a second Play bet or fold. If the player folds, the next step 335b requires that player to forfeit the Ante bet and the first Play bet to the dealer. If the player chooses to bet, in the next step 337b that player will place a second Play bet that is subject to the same constraints of the first Play bet. The next step 342 is for the dealer to reveal his or her cards.

Referring again to FIG. 4, after the dealer's hand is finalized, the next step 344 is to determine whether each player's hand beats the dealer's by comparing the hands based upon the three card poker rankings. If a player's hand does not beat the dealer's hand by having a higher three card poker ranking, the next step 345 for that player is to forfeit his or her Ante and Play bets to the dealer and the game is over for that player.

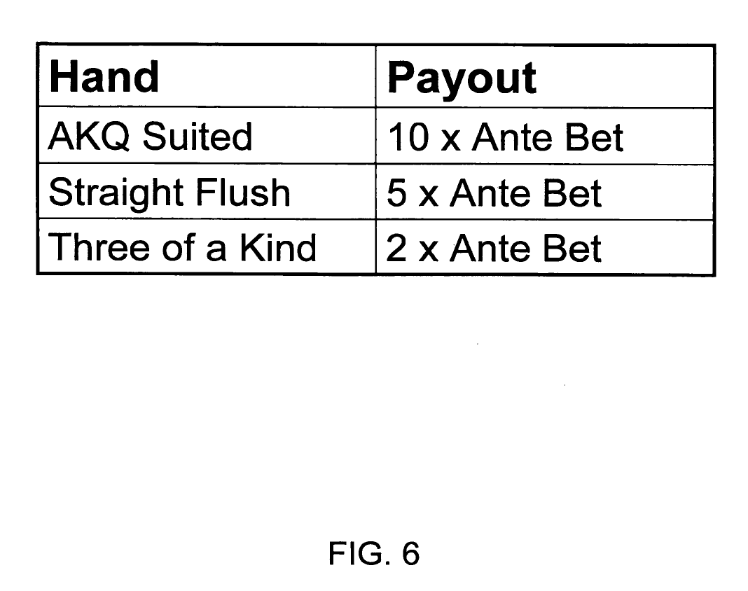

If a player's hand does beat the dealer's hand, however, the next step 346 is to pay the Ante and Play bets to that player. In a preferred embodiment the Ante and Play bets are paid 1 to 1. Also in a preferred embodiment, the next step 347 requires the payment of an Ante Bonus to each player whose hand meets a predetermined poker ranking based on an Ante Bonus paytable, an example of which is shown in FIG. 6. The Ante Bonus payouts are based on the amount of the player's Ante bet, allowing the player to further benefit from a high Ante bet and a high ranking hand. Furthermore, the Ante Bonus is preferably paid only when the player's hand beats the dealer's hand. Once all bets have been paid, the game is over.

### Four Card Draw Variants

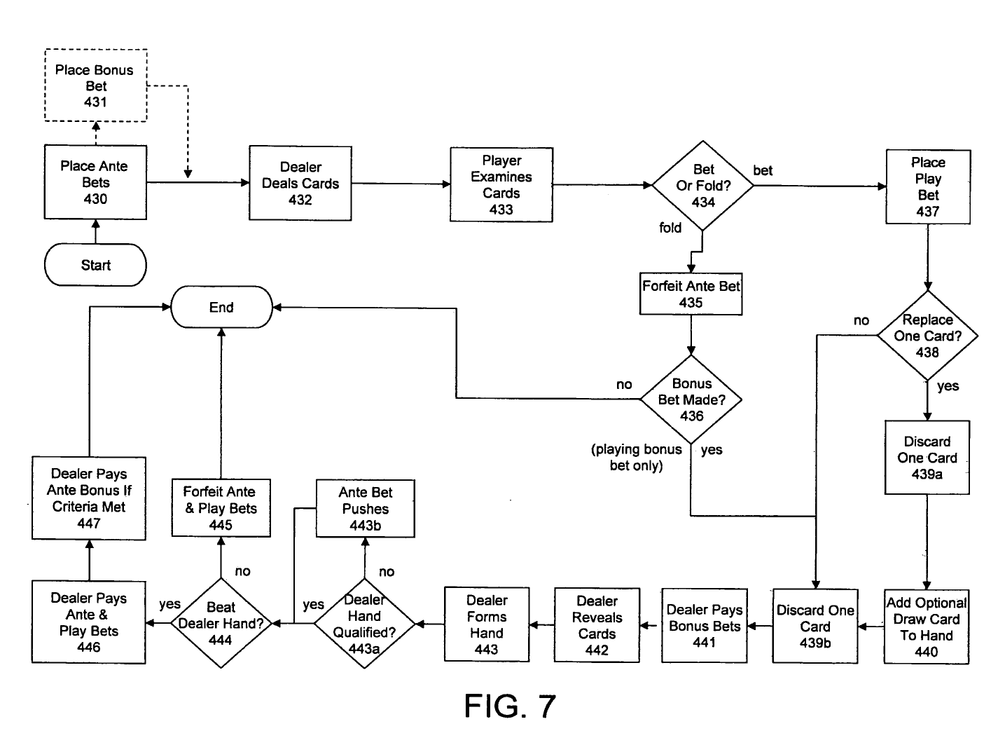

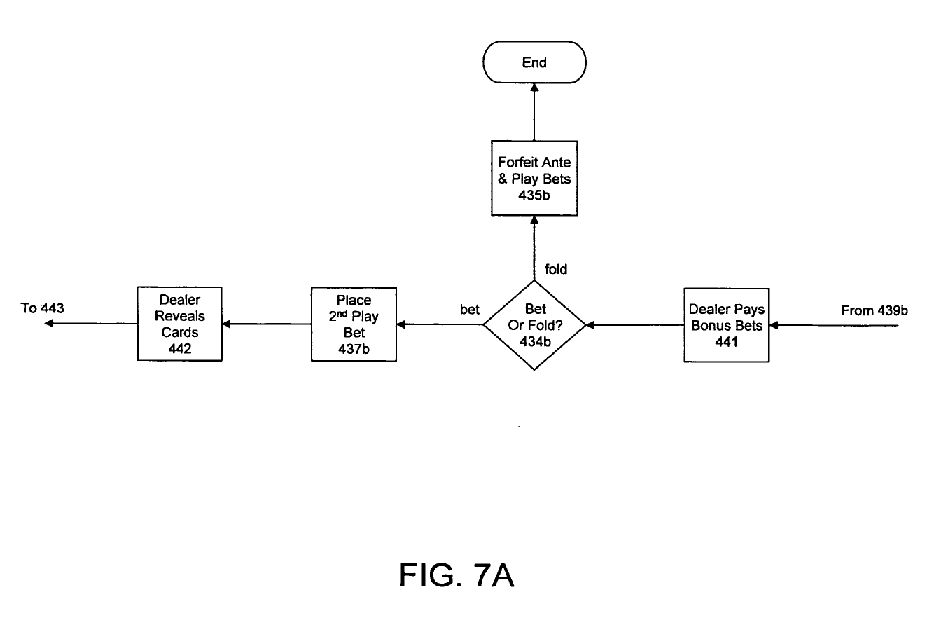

FIG. 7 shows a method according to another embodiment of the invention using four card poker hands. All steps with the same last two numbers, e.g. 430 (FIG. 7), 330 (FIG. 4), are substantially the same as those steps in FIG. 4. In addition to having a different number of cards in each hand, another difference between the games in FIGS. 4 (three cards) and 7 (four cards) is that the game in FIG. 7 includes two steps 439a, 439b where a card is discarded, in contrast to the game of FIG. 4 which has only one discard step 339. Also different from the game in FIG. 4, in a preferred embodiment of the game in FIG. 7, if the dealer's hand does not qualify with a pair or better, the ante bet pushes and is returned to the player.

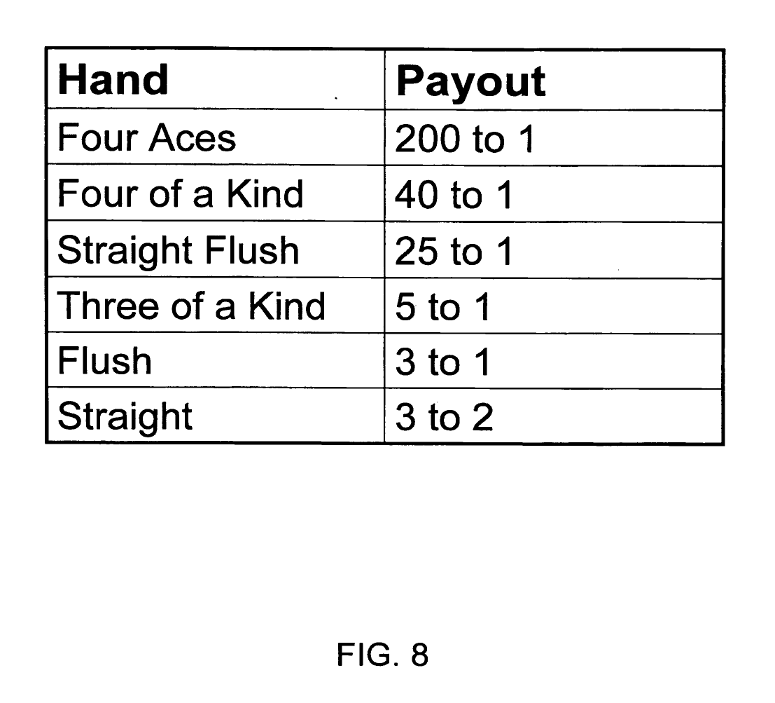

Looking in more detail at FIG. 7, the first step 430 requires a player to place an Ante bet, whereby the player is betting that his or her eventual four card poker hand will have a higher four card poker ranking than the dealer. As an optional next step 431, the player may place a Bonus bet strictly on the eventual value of the player's own hand which is paid independent of the dealer's hand according to a predetermined criteria. In a preferred embodiment, the bonus bet pays regardless of whether the player folds on the Ante wager. House rules may dictate that the bonus be paid only if the player made a play wager. In a preferred embodiment, the predetermined criteria is a paytable, an example of which is shown in FIG. 8. As shown in FIG. 7 at the next step 432, five cards and one optional draw card are dealt to each player, all face down. Then, six cards are dealt face down to the dealer. Again, card dealing can be performed by the dealer if desired. In the next step 433, each player examines his or her cards, except the optional draw card.

After viewing his or her cards, the next step 434 for each player is to decide whether to bet on the strength of his or her hand compared to the dealer's still unknown hand or fold. If the player decides to fold, the next step 435 for that player is to forfeit the Ante bet to the dealer. After folding, the next step 436 is to identify whether the folding player also placed a Bonus bet in step 431. If the player did not also place a Bonus bet, the game is over for that player. If the player did place a Bonus bet, however, the next step 439b for that player is to discard one card leaving that player with the best four card poker hand of the five original cards.

If the player decides to bet at step 434 that his or her hand has a higher four card poker ranking than that of the dealer's hand, the next step 437 for that player is to place a Play bet. In a preferred embodiment, the Play bet must be a multiple of the Ante bet, e.g., double or triple the Ante bet, preferably with a minimum Play bet equal to two times the Ante bet and a maximum Play bet equal to three times the Ante bet.

After all Play bets are placed by any remaining players, the next step 438 gives each player an option to replace one card in his or her hand with his or her optional draw card in an effort to better his or her hand. If the player decides to replace a card, the next step 439a is to choose which card to replace, and discard that card, and then at step 440, to add the optional draw card to the player's hand. While the preferred embodiment requires the player to discard one card before looking at the optional draw card, other embodiments may allow the player to look at the optional draw card before choosing which card to discard.

After the player has added the optional draw card to his or her hand, the next step 439b is to discard another card, thus finalizing the player's four card hand. After each player has finalized his or her hand, the next step 441 requires they payment of all winning Bonus bets to players according to a predetermined criteria. In a preferred embodiment, the predetermined criteria is a paytable, an example of which is shown in FIG. 8.

After Bonus bets are paid, as shown in FIG. 7, the next step 442 requires the dealer to reveal all six of his or her cards. In the next step 443, the dealer forms a hand by choosing his or her four cards that form the highest-raking poker hand and discarding the other two cards. In a preferred embodiment, four card poker rankings are used, which rank cards from highest to lowest as follows: four of a kind, straight flush, three of a kind, flush, straight, two pair. If no hand contains a pair or better, the hand that contains the highest ranking cards wins with an Ace being high. An Ace is low, however, when used in an A-2-3-4 straight.

In an alternative embodiment shown in FIG. 7A, players may place a second Play bet after their hands are finalized and before the dealer's cards are revealed. Looking at step 434b, after the Bonus bets are paid to the players in step 441, each player will be given the option to place a second Play bet or fold. If the player folds, the next step 435b requires that player to forfeit the Ante bet and the first Play bet to the dealer. If the player chooses to bet, in the next step 437b that player will place a second Play bet that is subject to the same constraints of the first Play bet. The next step 442 is for the dealer to reveal his or her cards.

Referring again to FIG. 7, after the dealer's hand is formed in step 443, the next step 443b is to determine if the dealer's hand qualifies. In a preferred embodiment, a dealer's hand qualifies with a pair or better. If the dealer's hand does not qualify, the next step 443b is that each player's Ante bet pushes and is returned to the player. In a preferred embodiment, bonus and play wagers remain in action when the dealer does not qualify. In other embodiments, the play wager is lost to the house.

After all pushed Ante bets are returned to the players in step 443b, or if the dealer's hand qualified in step 443a, the next step 444 is to determine whether each player's hand beats the dealer's by comparing the four card poker ranking of the hands. If a player's hand does not beat the dealer's hand by having a higher four card poker ranking, the next step 445 for that player is to forfeit the Ante and Play bets to the dealer and the game is over for that player. The Ante bet, however, would only be forfeited if not returned to the player in step 443b.

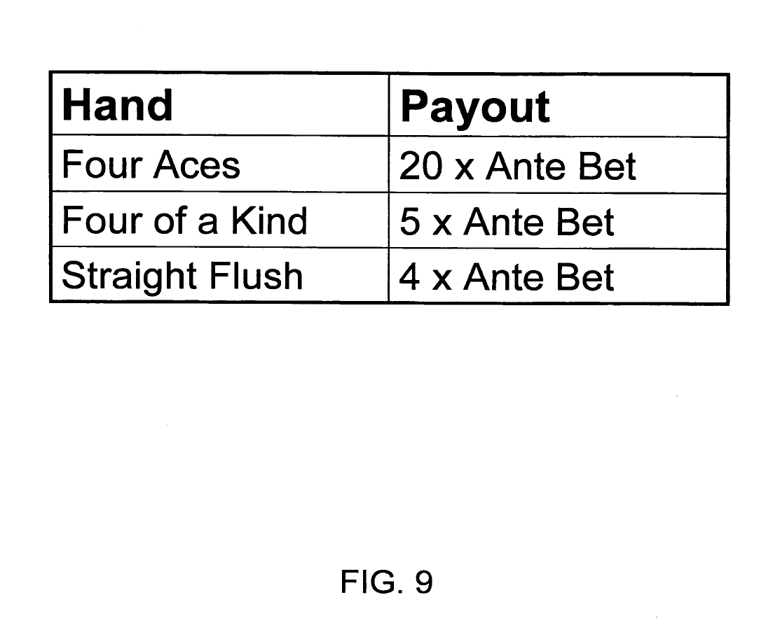

If a player's hand does beat the dealer's hand, however, the next step 446 is to pay the Ante and Play bets to that player. (Ante bets, however, are not paid if returned to the player in step 443b). In a preferred embodiment the Ante and Play bets are paid 1 to 1. Also in a preferred embodiment, the next step 447 requires the payment of an Ante Bonus to each player whose hand meets a predetermined poker ranking based on an Ante Bonus paytable, an example of which is shown in FIG. 9. The Ante Bonus payouts are based on the amount of the player's Ante bet, allowing the player to further benefit from a high Ante bet and a high ranking hand. Furthermore, the Ante Bonus is preferably paid only when the player's hand beats the dealer's hand and only if the Ante bet has not been returned. Once all bets have been paid, the game is over.

### Five Card Draw Variant

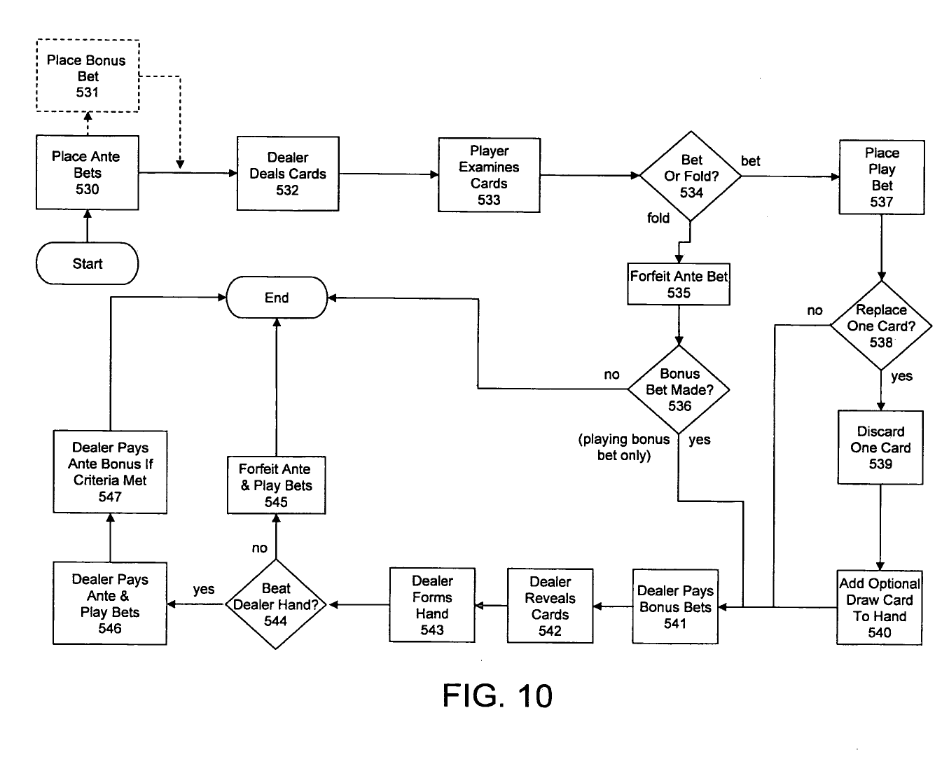

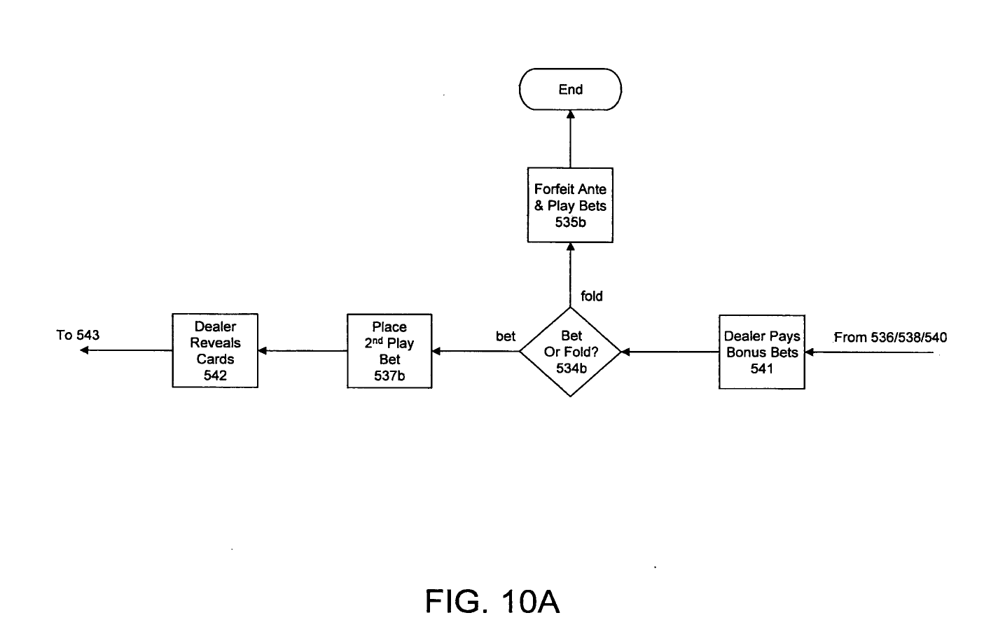

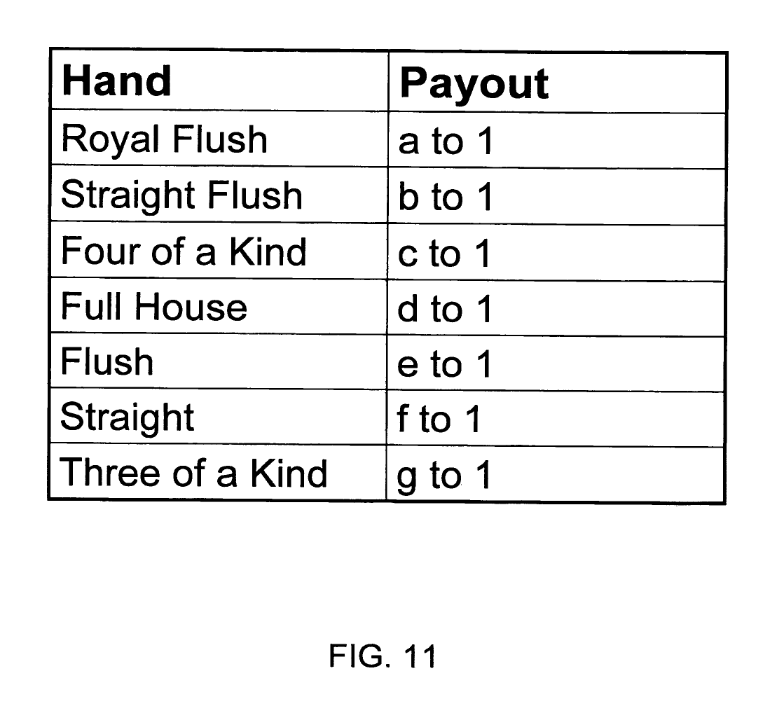

FIG. 10 shows a method according to another embodiment of the invention using five card poker hands. All steps with the same last two numbers, e.g. 530 (FIG. 10), 430 (FIG. 7), 330 (FIG. 4), are substantially the same as those steps in FIGS. 4 and 7. The first step 530 requires a player to place an Ante bet. By placing the Ante bet, the player is betting that his or her eventual five card poker hand will have a higher five card poker ranking than the dealer. As an optional next step 531, the player may place a Bonus bet on the eventual value of the player's own hand, which is paid independent of the dealer's hand according to a predetermined criteria. In a preferred embodiment, the predetermined criteria is a paytable, an example of which is shown in FIG. 11. The variables a through g in FIG. 11 can equal any numbers which give the house the desired advantage.

Referring again to FIG. 10, in the next step 532, five cards and one optional draw card are dealt to each player, all face down. Then, six cards are dealt face down to the dealer. Card dealing can be performed by the dealer if desired. In the next step 533, each player examines his or her cards, except the optional draw card.

After viewing his or her cards, the next step 534 for each player is to decide whether to bet on the strength of his or her hand compared to the dealer's still unknown hand or fold. If the player decides to fold, the next step 535 for that player is to forfeit the Ante bet to the dealer. After folding, the next step 536 is to identify whether the folding player also placed a Bonus bet in step 531. If the player did not also place a Bonus bet, the game is over for that player. If the player did place a Bonus bet, however, the next step 541 for that player will be to receive payment on the Bonus bet according to a predetermined criteria. In a preferred embodiment, the predetermined criteria is a paytable, an example of which is shown in FIG. 11. House rules dictate whether the bonus bet can be paid when the player folds.

Referring again to FIG. 10, if the player decides to bet in step 534 that his or her hand has a higher five card poker ranking than that of the dealer's hand, the next step 537 for that player is to place a Play bet. In a preferred embodiment, a player's Play bet must be a multiple of the Ante bet, e.g., double or triple the Ante bet, preferably with a minimum Play bet equal to two times the Ante bet and a maximum Play bet equal to three times the Ante bet.

After all Play bets are placed by any remaining players, the next step 538 gives each player an option to replace one card in his or her hand with his or her optional draw card in an effort to better his or her hand. If the player decides to replace a card, the next step 539 is to choose which card to replace, and discard that card, and then at step 540, to add the optional draw card to the player's hand to finalize the hand. While the preferred embodiment requires the player to discard one card before looking at the optional draw card, other embodiments may allow the player to look at the optional draw card before choosing which card to discard.

After each player has finalized his or her hand, the next step 541 requires the payment of all winning Bonus bets to players according to a predetermined criteria. In a preferred embodiment, the predetermined criteria is a paytable, an example of which is shown in FIG. 11. After Bonus bets are paid, as shown in FIG. 10, the next step 542 requires the dealer to reveal all six of his or her cards. In the next step 543, the dealer forms a hand by choosing his or her five cards that form the highest-raking poker hand and discarding the sixth card. In a preferred embodiment, standard five card poker rankings are used.

In an alternative embodiment shown in FIG. 10A, players may place a second Play bet after their hands are finalized and before the dealer's cards are revealed. Looking at step 534b, after the Bonus bets are paid to the players in step 541, each player will be given the option to place a second Play bet or fold. If the player folds, the next step 535b requires that player to forfeit the Ante bet and the first Play bet to the dealer. If the player chooses to bet, in the next step 537b that player will place a second Play bet that is subject to the same constraints of the first Play bet. The next step 542 is for the dealer to reveal his or her cards.

Looking again at FIG. 10, after the dealer's hand is finalized, the next step 544 is to determine whether each player's hand beats the dealer's by comparing the dealer's five card poker ranking with that of each player. If a player's hand does not beat the dealer's hand by having a higher five card poker ranking, the next step 545 for that player is to forfeit the Ante and Play bets to the dealer and the game is over for that player.

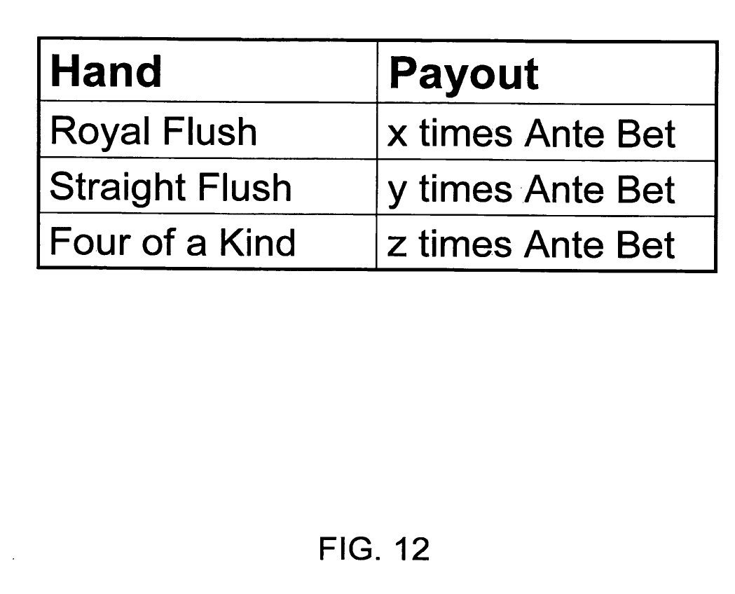

If a player's hand does beat the dealer's hand, however, the next step 546 is to pay the Ante and Play bets to that player. In a preferred embodiment the Ante and Play bets are paid 1 to 1. Also in a preferred embodiment, the next step 547 requires the payment of an Ante Bonus to each player whose hand meets a predetermined poker ranking based on an Ante Bonus paytable, an example of which is shown in FIG. 12. The variables x, y and z in FIG. 12 can equal any numbers which give the house the desired advantage. The Ante Bonus payouts are based on the amount of the player's Ante bet, allowing the player to further benefit from a high Ante bet and a high ranking hand. Furthermore, the Ante Bonus is preferably paid only when the player's hand beats the dealer's hand. Once all bets have been paid, the game is over.

The above embodiments of the draw poker game of the present invention allow the dealer to set his hand with more information than the players use to set their hands. While the dealer can view all of his cards prior to selecting one or more discards, preferred forms of the invention require the players to discard before seeing the draw card.

Some versions of the game give the player a greater chance of improving the quality of the hand, but rules to improve the house advantage, (i.e., the dealer qualification rule) are added in order to assure the house maintains an advantage.

Advantageously, players may discard and draw without making an additional wager, a feature that is likely to appeal to players. In some, but not all embodiments, players are able to win on the play wager, even though the dealer did not qualify and the ante was declared a push.

The play wagers according to one aspect of the invention are not equal to the ante and are instead multiples of the ante. This adds volatility and excitement to the game, because of the higher potential payouts.

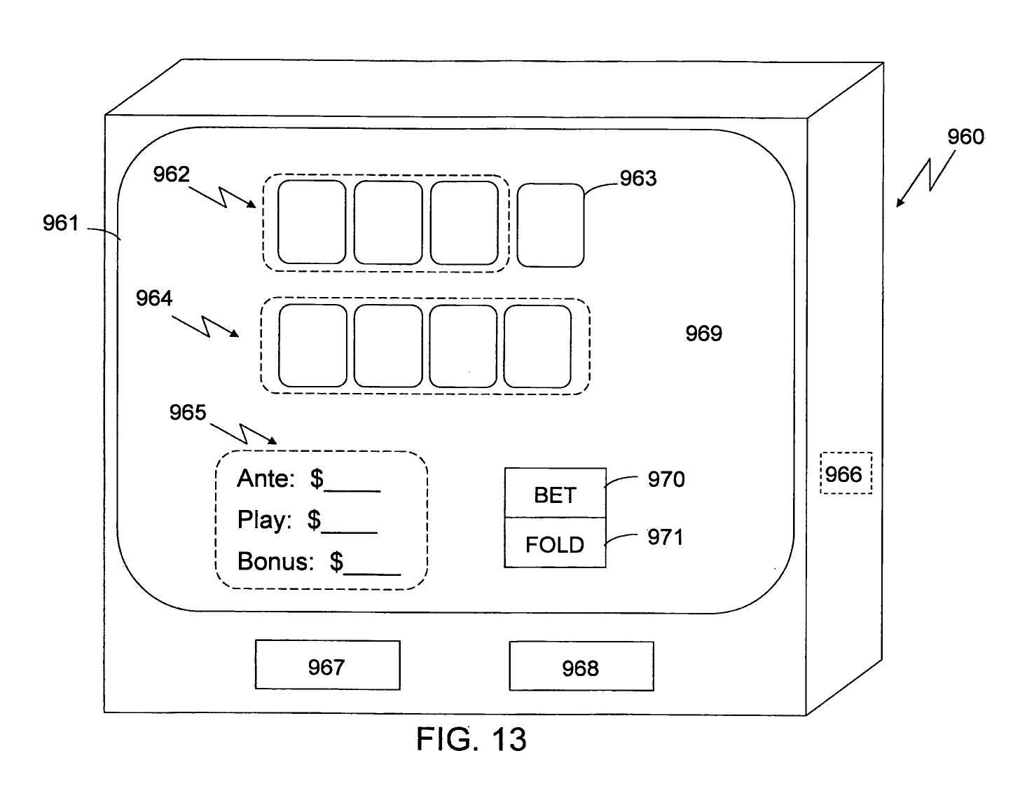

An embodiment of a video gaming format is shown in FIG. 13, which can be used to play the embodiments as shown in FIGS. 4-12. FIG. 13 shows a game machine 960, which has a video screen 961. The video screen 961 can be an LCD, CRT, plasma, or any other type of video screen. The video screen 961 may show a player's cards 962, the player's optional draw card 963, and the dealer's cards 964, where the dealer's cards are revealed only after the player places the Play bet. The video screen 961 may also show the value of each bet that a player has placed 965. The game machine 960 may be a stand-alone unit or may be internet-connected or networked with other machines. The game machine 960 can have a processor 966 or a hard-wired circuit programmed to run a game as discussed above in relation to FIGS. 4-12, which may be played by a player. The game machine 960 can utilize a touch screen 969 such that the machine 960 receives input from the player by the player touching the screen 961. Commands for betting and folding can be input during a game using virtual buttons 970 and 971 via the touch screen 969. Commands for discarding can be input by touching the cards themselves via the touch screen 969. Amounts of bets can be entered by a numerical touch screen keyboard or by touch screen buttons showing a bet amount which can be selected.

The game machine 960 can include a means for accepting money to play the game 967; for example a coin, token or bill acceptor, a credit or debit card or other card slot, or other means of accepting payment. Such a machine 960 may also include a payout slot 968 so that a winning player receives payout as he or she would at a casino table. The payout slot may dispense coins, bills, tokens or receipts than can be exchanged for currency.

Many other game play formats, aside from live gaming are contemplated, including practice-play formats such as personal computer, personal play station, cell phone and parlour game formats. Examples of wagering formats contemplated include single video gaming machines, multi-player gaming machines, wireless gaming, remote betting, internet gaming and the like. Hybrid video gaming systems utilizing virtual cards or chips or both are also contemplated.

The above description and drawings should be considered illustrative of example embodiments that achieve the features and advantages of the invention. Accordingly, the invention is not to be considered as being limited by the foregoing description and drawings, but is only limited by the scope of the appended claims.

What is claimed as new and desired to be protected by Letters Patent of the United States is:

1. A method of playing a card game comprising:
a player placing an Ante to participate in the game;
a dealer dealing a plurality of cards to each player;
a dealer dealing one draw card to each player position;
a dealer dealing a plurality of cards to a dealer;
providing each player an opportunity to discard the one card and then replace with the at least one draw card, the at least one draw card becoming part of a player's hand to form a best player hand, such replacement made without the player placing an additional wager;
forming a best dealer hand from fewer than all cards dealt to the dealer, the best dealer hand containing the same number of cards as each best player hand;
each player placing a Play wager that is a multiple of the Ante or folding;
comparing each player's best hand with the best dealer hand based on the predetermined card rankings; and
resolving all bets, wherein each of the plurality of cards dealt to the dealer is dealt face down, and wherein the number of cards initially dealt to the dealer is at least one more than the number of the plurality of cards initially dealt to each player.

2. The method of claim 1, further comprising:
requiring each player to place an Ante bet before the cards are dealt; and
allowing each player to place an optional Bonus bet, such Bonus bet paid independent of the dealer hand and based on a predetermined criteria.

3. The method of claim 1, wherein the plurality of cards dealt to each player is selected from the group consisting of three and five cards.

4. The method of claim 1, wherein the play bet has a minimum equal to two times the ante bet and a maximum equal to three times the Ante bet.

5. The method of claim 1, wherein the multiple is selectable by the player.

6. The method of claim 1, wherein the Ante and Play bets are resolved in favor of the player only if the player's best hand beats the best dealer hand based on poker ranking.

7. The method of claim 1, wherein the Ante bet is resolved in favor of the player only if the best dealer hand qualifies.

8. The method of claim 1, wherein an ante bonus is paid based on the Ante bet if the Ante bet is paid and if the player's best hand achieves a predetermined ranking.

9. The method of claim 2, wherein the predetermined criteria comprises an odds paytable.

10. The method of claim 1, wherein the best dealer hand and each player's best hand respectively consists of three cards.

11. The method of claim 1, wherein the best dealer hand and each player's best hand respectively consists of four cards.

12. The method of claim 1, wherein the best dealer hand and each player's best hand respectively consists of five cards.

13. The method of claim 1, wherein each player is provided the opportunity to place a second Play bet after the opportunity to replace at least one card.

14. A method of playing a card game with at least one player, comprising:
requiring the at least one player to place an Ante bet;
allowing the player to place an optional Bonus bet;
dealing three cards to the player to create a player hand;
dealing four cards face down to a dealer;
dealing one draw card to the player;
allowing the player to fold or place a play bet in an amount that is a multiple of the Ante after viewing the player's cards;
allowing the player the opportunity to discard only one player card and then replace one of the player's cards with at least one optional draw card, such replacement made without the player placing a separate bet;
creating a dealer hand by discarding one dealer card; and
paying the player on the Ante and Play bets only when the player's hand outranks the dealer's hand in accordance with a poker hand ranking wherein paying the player on the bonus bet based on the player's hand and according to a bonus paytable.

15. The method of claim 14, wherein an Ante bonus is paid according to Ante bonus paytable when the player's hand outranks the dealer's hand.

16. The method of claim 14, wherein the bonus paytable is:

| Hand | Odds |
|---|---|
| Ace, King, Queen of Same Suit | 100:1 |
| Straight Flush | 30:1 |
| Three of a kind | 25:1 |
| Straight | 3:1 |
| Flush | 1:1 |

17. The method of claim 15, wherein the ante bonus paytable is:

| Hand | Payout |
|---|---|
| Ace, King, Queen of Same Suit | 10 times ante bet |
| Straight Flush | 5 times ante bet |
| Three of a kind | 2 times ante bet |

18. The method of claim 14, wherein the predetermined number of draw cards is one.

19. The method of claim 14, wherein the Play bet is a multiple of the Ante selected from the range of two times to three times the Ante, and the multiple is selectable by the player.

20. A method of playing a card game with at least one player, comprising:
requiring the at least one player to place an Ante bet;
allowing the player to place an optional Bonus bet;
dealing five cards to the player to create a player hand;
dealing six cards face down to a dealer;
dealing one optional draw card to the player;
allowing the player to fold or place a play bet that is a multiple of the Ante after viewing the player's cards;
allowing the player an opportunity to replace one of the player's cards with the optional draw card without making an additional bet;
creating a dealer hand by discarding at least one dealer card; and
paying the player on the Ante and Play bets only when the player's hand outranks the dealer's hand in accordance with a poker hand ranking and paying the player on the Bonus bet based on the player's hand and according to a bonus paytable.

21. The method of claim 20, wherein the Ante bet is resolved in favor of the player only if the best dealer hand qualifies.

22. The method of claim 20 wherein the multiple is selectable by the player.

23. The method of claim 20, wherein an Ante bonus is paid according to ante bonus paytable only if the Ante bet is won.

24. The method of claim 20, wherein the dealer discards a number of cards selected from the group consisting of 1 and 2.

25. The method of claim 20, and further comprising the step of the player discarding an additional card to form a final hand.

26. A game machine comprising:
a video screen;
a player input device;
a payment input device;
a payout device; and
a processor configured to perform at least the following steps:
providing the player at least one opportunity to make an Ante bet;
dealing a plurality of cards to a player;
dealing one draw card to the player;
dealing a plurality of cards to a dealer, the dealer hand exceeding the player hand by one card;
providing the player only one opportunity to discard at least one card of the plurality dealt to a player and then replace with the at least one draw card to form a best player hand, such replacement made without the player placing an additional bet;
forming a best dealer hand from cards dealt to the dealer, the best dealer hand containing the same number of cards as the best player hand;
providing the player at least one opportunity to make a play bet that is a multiple of the Ante, or fold;
identifying the player's best hand and a best dealer hand based on predetermined card rankings;
comparing the player's best hand with the best dealer hand based on the predetermined card rankings; and
resolving all bets, wherein each of the plurality of cards dealt to the dealer is dealt face down, and wherein the number of cards dealt to the dealer is at least one more than the number of the plurality of cards dealt to each player.
